(19) United States
(12) Patent Application Publication
(10) Pub. No.: US 2026/0189618 A1
(43) Pub. Date: Jul. 2, 2026

(54) EXTENDED REALITY MEDIA SERVICE AUTHORIZATION METHOD AND APPARATUS, DEVICE, AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN); Yuxin MAO, Beijing (CN)

(73) Assignee: Beijing Xiaomi Mobile Software Co., Ltd., Beijing (CN)

(21) Appl. No.: 18/863,151

(22) PCT Filed: May 6, 2022
(86) PCT No.: PCT/CN2022/091297

§ 371 Date: Nov. 5, 2024

(51) Int. Cl. H04L 65/80; H04L 12/14; H04L 47/80; H04L 65/1069; H04L 65/1083

(52) U.S. Cl. CPC H04L 65/80; H04L 12/1407; H04L 47/801; H04L 65/1069; H04L 65/1086

(57) ABSTRACT

A method for authorizing an extended reality media service is performed by a Network Exposure Function (NEF), and includes: receiving a session request sent by an Application Function (AF), where the session request comprises relationship information between data streams in an extended reality media service group, and the relationship information comprises at least one of dependency information or priority information; and determining whether to authorize the data streams in the session request based on the relationship information.

### CROSS REFERENCE TO RELATED APPLICATION(S)

The present application is a U.S. National Stage of International Application No. PCT/CN2022/091297 filed on May 6, 2022, the content of which is incorporated herein by reference in its entirety for all purposes.

### TECHNICAL FIELD

The present disclosure relates to the field of wireless communication technology, and in particular to a method and apparatus for authorizing an extended reality media service, a device, and a storage medium.

### BACKGROUND

Mobile media services, cloud AR/VR and other XR services, cloud games, video-based machine or drone remote control, and other services are expected to contribute more and more traffic to 5G networks. XR services involve multimodal data streams. Multimodal data is data that describes the same service/application and is input from the same device or different devices (including sensors), which may be output to one or more destination device terminals.

XRM services require the 5GS system to comprehensively consider the Quality of Service (QoS) characteristics for the relevant data streams of the services. For example, for Guaranteed Bit Rate (GBR) data streams with strict latency requirements, it is necessary to consider whether parameters such as Guaranteed Flow Bit Rate (GFBR), Packet Delay Budget (PDB), and Default Maximum Data Burst Volume (MDBV) can be met and coordinated at the same time.

In addition, there are varying degrees of dependencies between multiple XRM data streams. For example, insufficient QoS protection for some data streams or data stream transmission failure will have a local impact on the entire XRM service, such as affecting user experience or some service functions. However, insufficient QoS protection for some data streams or data stream transmission failure will directly lead to the failure of the entire XRM service.

### SUMMARY

In view of above, the present disclosure provides a method and apparatus for authorizing an extended reality media service, a device, and a storage medium.

According to a first aspect of embodiments of the present disclosure, a method for authorizing an extended reality media service is provided, which is performed by a Network Exposure Function (NEF), including:
receiving a session request sent by an Application Function (AF), where the session request includes relationship information between data streams in an extended reality media service group, and the relationship information includes at least one of the following: dependency information or priority information; and
determining whether to authorize the data streams in the session request based on the relationship information.

According to a second aspect of embodiments of the present disclosure, a method for authorizing an extended reality media service is provided, which is performed by a Policy Control Function (PCF), including:
receiving a policy authorization request sent by a Network Exposure Function (NEF), where the policy authorization request includes an association processing indication and/or relationship information between data streams in an extended reality media service group included in a session request,
where the relationship information includes at least one of the following: dependency information or priority information, and the association processing indication indicates that association processing is applied to the data streams in the extended reality media service group.

According to a third aspect of embodiments of the present disclosure, a communication device is provided, including a processor and a memory, where
the memory is configured to store a computer program; and
the processor is configured to execute the computer program to implement the above-mentioned method for authorizing an extended reality media service.

According to a fourth aspect of embodiments of the present disclosure, a communication device is provided, including a processor and a memory, where
the memory is configured to store a computer program; and
the processor is configured to execute the computer program to implement the above-mentioned method for authorizing an extended reality media service.

It is to be understood that the foregoing general description and the following detailed description are examples and explanatory only and are not restrictive of the present disclosure.

### BRIEF DESCRIPTION OF THE DRAWINGS

The drawings described herein are used to provide a further understanding of embodiments of the present disclosure and constitute a part of the present application. The schematic implementations of the embodiments of the present disclosure and their descriptions are used to explain the embodiments of the present disclosure and do not constitute an improper limitation on the embodiments of the present disclosure.

The drawings herein are incorporated into the specification and constitute a part of the specification, showing implementations that conform to the embodiments of the present disclosure and are used together with the specification to explain the principles of the embodiments of the present disclosure.

FIG. 1 is a schematic diagram of a wireless communication system according to an example embodiment;

FIG. 2 is a flow chart of a method for authorizing an extended reality media service according to an example embodiment;

FIG. 3 is a flow chart of a method for authorizing an extended reality media service according to an example embodiment;

FIG. 4 is a flow chart of a method for authorizing an extended reality media service according to an example embodiment;

FIG. 5 is a flow chart of a method for authorizing an extended reality media service according to an example embodiment;

FIG. 6 is a flow chart of a method for authorizing an extended reality media service according to an example embodiment;

FIG. 7 is a flow chart of a method for authorizing an extended reality media service according to an example embodiment;

FIG. 8 is a flow chart of a method for authorizing an extended reality media service according to an example embodiment;

FIG. 9 is a flow chart of a method for authorizing an extended reality media service according to an example embodiment;

FIG. 10 is a flow chart of a method for authorizing an extended reality media service according to an example embodiment;

FIG. 11 is a flow chart of a method for authorizing an extended reality media service according to an example embodiment;

FIG. 12 is a flow chart of a method for authorizing an extended reality media service according to an example embodiment;

FIG. 13 is a flow chart of a method for authorizing an extended reality media service according to an example embodiment;

FIG. 14 is a flow chart of a method for authorizing an extended reality media service according to an example embodiment;

FIG. 15 is a block diagram of an apparatus for authorizing an extended reality media service according to an example embodiment;

FIG. 16 is a block diagram of an apparatus for authorizing an extended reality media service according to an example embodiment; and

FIG. 17 is a structural diagram of a data stream authorization device according to an example embodiment.

### DETAILED DESCRIPTION OF THE EMBODIMENTS

The embodiments of the present disclosure are now further described in conjunction with the drawings and specific embodiments.

The example embodiments will be described in detail here, and examples thereof are shown in the drawings. When the following description refers to the drawings, unless otherwise indicated, the same numbers in different drawings represent the same or similar elements. The implementations described in the following example embodiments do not represent all the implementations consistent with the embodiments of the present disclosure. Instead, they are only examples of devices and methods consistent with some aspects of the present disclosure as detailed in the attached claims.

It should be noted that an embodiment of the present disclosure may include multiple steps. For ease of description, these steps are numbered, but these numbers are not limitations on the execution time slots and execution order between steps. These steps may be implemented in any order, and the embodiments of the present disclosure do not limit this.

In the description of the present application, the words “first”, “second”, “third”, etc. are only used for the purpose of distinguishing the description, and cannot be understood as indicating or implying relative importance, nor can they be understood as indicating or implying order. “Multiple” means two or more.

“And/or” describes the association relationship between the associated objects, indicating that there may be three relationships. For example, A and/or B may be expressed as: A exists alone, A and B exist at the same time, and B exists alone.

The data streams in multimodal data often have certain or even strong correlations, such as the synchronization of audio and video streams, the synchronization of touch and vision, etc. There are some common characteristics in the data streams of this type of media services, between the data streams, and the network transmission requirements of these service data streams. The effective identification and utilization of these characteristics will be more conducive to the transmission and control of the network and services, and will also be more conducive to service assurance and user experience.

There are different degrees of dependencies between multiple XRM data streams. For example, insufficient QoS guarantee or data stream transmission failure of some data streams will have a local impact on the entire XRM service, such as affecting user experience or some service functions. But insufficient QoS guarantee or data stream transmission failure of some data streams will directly lead to the failure of the entire XRM service. The identification and coordination of such data streams with different dependencies or priorities is an important and non-negligible requirement in actual XRM services. However, the current 5GS system does not have a perfect mechanism to support these requirements of XRM services and multimodal services between multiple UEs, and there is no corresponding technical solution to support the functional characteristics of identification and coordination of dependency or priority relationships between multiple XRM data streams of a UE, or between XRM data streams of multiple UEs.

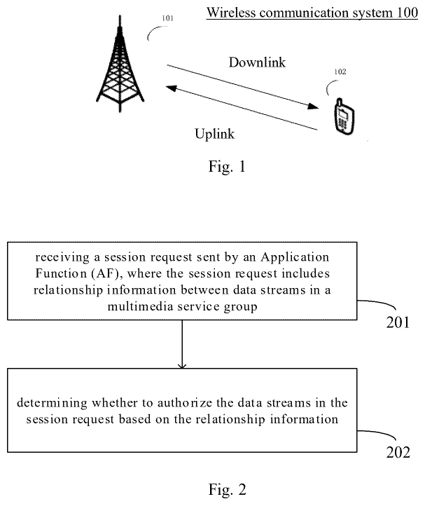

As shown in FIG. 1, a method for authorizing an extended reality media service provided in an embodiment of the present disclosure may be applied to a wireless communication system 100, which may include, but is not limited to, a network device 101 and a user device 102. The user device 102 is configured to support carrier aggregation. The user device 102 may be connected to multiple carrier units of the network device 101, including a main carrier unit and one or more auxiliary carrier units.

It should be understood that the above wireless communication system 100 may be applied to both low-frequency scenarios and high-frequency scenarios. The application scenarios of the wireless communication system 100 include, but are not limited to, long term evolution (LTE) system, LTE frequency division duplex (FDD) system, LTE time division duplex (TDD) system, worldwide interoperability for micro wave access (WiMAX) communication system, cloud radio access network (CRAN) system, future fifth generation (5G) system, new radio (NR) communication system, or future evolved public land mobile network (PLMN) system, etc.

The user device 102 shown above may be user equipment (UE), terminal, access terminal, terminal unit, terminal station, mobile station (MS), remote station, remote terminal, mobile terminal, wireless communication device, terminal agent, or user facility, etc. The user device 102 may have a wireless transceiving function. The user device 102 may communicate with one or more network devices 101 of one or more communication systems (such as wireless communication), and receive network services provided by the network device 101. The network device 101 includes, but is not limited to, the base station shown in the drawings.

The user device 102 may be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle-mounted device, a wearable device, a user device in a future 5G network, or a user device in a future evolved PLMN network, etc.

The network device 101 may be an access network device (or access network site). The access network device refers to a device that provides network access function, such as a radio access network (RAN) base station, etc. The network device may specifically include a base station (BS) device, or a base station device and a wireless resource management device for controlling the base station device, etc. The network device may also include a relay station (relay device), an access point, a base station in a future 5G network, a base station in a future evolved PLMN network, or a NR base station. The network device may be a wearable device or a vehicle-mounted device. The network device may also be a communication chip with a communication module.

The core network device in the wireless communication system 100 includes, for example, an Access and Mobility Management Function (AMF), a Session Management Function (SMF), a User Plane Function (UPF), a Network Exposure Function (NEF), a NF Repository Function (NRF), or a Policy and Charging Function (PCF), etc.

An embodiment of the present disclosure provides a method for authorizing an extended reality media service, which is performed by a Network Exposure Function (NEF). FIG. 2 is a flowchart of a method performed by NEF according to an example embodiment.

As shown in FIG. 2, the method includes:
step 201, receiving a session request sent by an Application Function (AF), where the session request includes relationship information between data streams in an extended reality media service group, and the relationship information includes at least one of the following: dependency information or priority information; and
step 202, determining whether to authorize the data streams in the session request based on the relationship information.

The multimedia data stream of the present disclosure may be an XRM data stream, i.e., an extended reality multimedia data stream.

In an embodiment, NEF receives a session request sent by AF. The session request includes relationship information between data streams in an extended reality media service group. The relationship information may be dependency information about the dependency relationship between data streams and/or priority information about the priority relationship between data streams. As described above, there are dependency relationships and/or priority relationships of different degrees between multiple XRM data streams. Thus, when authorizing multiple data streams with dependency relationships and/or priority relationships, the mutual relationships between these data streams need to be considered. NEF determines whether to authorize these data streams based on the relationship information included in the received session request.

In an embodiment, NEF receives the above session request by receiving Nnef_AFsessionWithQoS_Create request sent by AF. In addition to dependency information and/or priority information, the session request also carries relevant information about the XRM service group, such as service group identifier (Group ID), user equipment address (UE address)/user equipment identifier (UE Identifier), AF identifier, application identifier (Application ID), flow description(s), Data Network Name (DNN), single network slice selection assistance information (S-NSSAI), QoS parameter, and other corresponding information. Here, Group ID may be used to identify all the data streams or all the user equipments UE in the XRM service group.

In an embodiment, when NEF authorizes a data stream, it performs a relevant mapping operation, such as mapping of XRM service identifier (AF-Service-Identifier) to DNN and S-NSSAI, mapping of external application to core network (CN) application identifier, mapping of external UE identifier to UE identifier in CN based on contract information of unified data management (UDM) (such as subscriber permanent identifier (SUPI)), and mapping of external to internal XRM service group identifiers performed according to UDM contract information.

In the above embodiment(s), NEF receives the dependency relationship and/or the priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

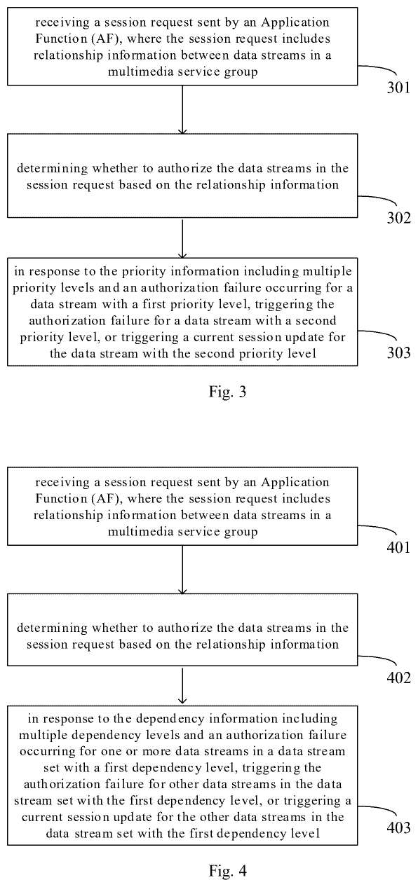

An embodiment of the present disclosure provides a method for authorizing an extended reality media service, which is performed by a Network Exposure Function (NEF). FIG. 3 is a flowchart of a method performed by NEF according to an example embodiment.

As shown in FIG. 3, the method includes:
step 301, receiving a session request sent by an Application Function (AF), where the session request includes relationship information between data streams in an extended reality media service group, and the relationship information includes at least one of the following: dependency information or priority information;
step 302, determining whether to authorize the data streams in the session request based on the relationship information; and
step 303, in response to the priority information including multiple priority levels and an authorization failure occurring for a data stream with a first priority level, triggering the authorization failure for a data stream with a second priority level, or triggering a current session update for the data stream with the second priority level,
where the first priority level is higher than the second priority level.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize these data streams based on the relationship information included in the received session request. In a scenario where the priority information of the data streams includes multiple priority levels, if an authorization failure occurs for a data stream with a first priority level (i.e., a high priority level), the authorization failure for a data stream with a second priority level (i.e., a low priority level) in a new session request is triggered, or a current session update for the data stream with the second priority level in a current session request is triggered. That is, the authorization failure for a data stream with a high priority level will trigger the authorization failure or current session update for a data stream with a low priority level in a subsequent session request. This indicates that a data stream with a low priority level will be affected by the authorization failure for a data stream with a high priority level.

In an embodiment, the current session update for the data stream with the second priority level includes a current Packet Data Unit (PDU) session update for the data stream with the second priority level.

In an embodiment, the current session update for the data stream with the second priority level includes a current PDU session update and QoS authorization withdrawal for the data stream with the second priority level. In an embodiment, the current session update for the data stream with the second priority level includes a current PDU session update and AF session release for the data stream with the second priority level. In an embodiment, the current session update for the data stream with the second priority level includes current PDU session update, QoS authorization withdrawal, and AF session release for the data stream with the second priority level.

In the above implementation(s), NEF receives the dependency relationship and/or the priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Network Exposure Function (NEF). FIG. 4 is a flow chart of a method performed by NEF according to an example embodiment.

As shown in FIG. 4, the method includes:
step 401, receiving a session request sent by an Application Function (AF), where the session request includes relationship information between data streams in an extended reality media service group, and the relationship information includes at least one of the following: dependency information or priority information;
step 402, determining whether to authorize the data streams in the session request based on the relationship information; and
step 403, in response to the dependency information including multiple dependency levels and an authorization failure occurring for one or more data streams in a data stream set with a first dependency level, triggering the authorization failure for other data streams in the data stream set with the first dependency level, or triggering a current session update for the other data streams in the data stream set with the first dependency level,
where the data streams in the data stream set with the first dependency level are dependent on each other.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize these data streams based on the relationship information included in the received session request. In a scenario where the dependency relationship of data streams includes multiple dependency levels, if an authorization failure occurs for a data stream in the data streams with the first dependency level (i.e., a relatively strong dependency level), then the authorization failure for other data streams with a strong dependency relationship with the data stream, for which the authorization failure occurs, is triggered in a new session request, or the current session update for other data streams with a strong dependency relationship with the data stream, for which the authorization failure occurs, is triggered in the current session request.

Here, the data streams in the data stream set with the first dependency level are dependent on each other, indicating that the data streams in the data stream set with the first dependency level have a strong dependency relationship. That is, in a case that the dependency relationship between multiple data streams is strong, if an authorization failure occurs for a data stream in the multiple data streams, the authorization failure or current session update for other data streams in the multiple data streams will be triggered in a subsequent session request. This indicates that data streams with a strong dependency relationship will affect the authorization for each other. Data streams with no dependency or with a weak dependency relationship may not affect the authorization for each other, or the possibility in affecting the authorization for each other is small.

In an embodiment, the current session update for the other data streams in the data stream set with the first dependency level includes the current PDU session update for the other data streams.

In an embodiment, the current session update for the other data streams in the data stream set with the first dependency level includes the current PDU session update and QoS authorization withdrawal for the other data streams. In an embodiment, the current session update for the other data streams in the data stream set with the first dependency level includes the current PDU session update and AF session release for the other data streams. In an embodiment, the current session update for the other data streams in the data stream set with the first dependency level includes the current PDU session update, QoS authorization withdrawal and AF session release for the other data streams.

In the above embodiment(s), NEF receives the dependency information and/or priority relationship of the media service group in the session request, and determines whether to authorize the data streams based on these relationships. In this way, these relationships between data streams can be effectively identified and utilized, which is helpful for the transmission and control of the network and services, and is also more helpful for service assurance and user experience.

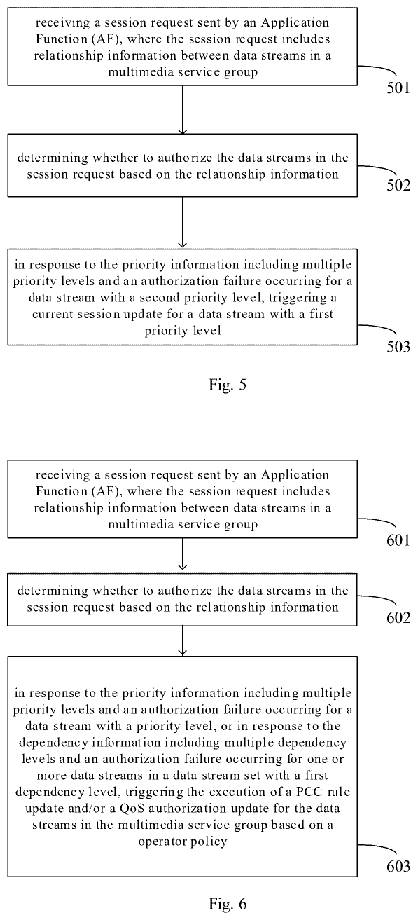

An embodiment of the present disclosure provides a method for authorizing an extended reality media service, which is performed by a Network Exposure Function (NEF). FIG. 5 is a flow chart of a method performed by NEF according to an example embodiment.

As shown in FIG. 5, the method includes:
step 501, receiving a session request sent by an Application Function (AF), where the session request includes relationship information between data streams in an extended reality media service group, and the relationship information includes at least one of the following: dependency information or priority information;
step 502, determining whether to authorize the data streams in the session request based on the relationship information; and
step 503, in response to the priority information including multiple priority levels and an authorization failure occurring for a data stream with a second priority level, triggering a current session update for a data stream with a first priority level,
where the first priority level is higher than the second priority level.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize these data streams based on the relationship information included in the received session request. In a scenario where the priority information of the data streams includes multiple priority levels, if an authorization failure occurs for a data stream with a second priority level (i.e., a low priority level), a current session update for a data stream with a first priority level (i.e., a high priority level) is triggered. That is, the authorization failure for a data stream with a low priority level will trigger the current session update for a data stream with a high priority level. This indicates that a data stream with a high priority level will be affected by the authorization failure for a data stream with a low priority level.

In an embodiment, the current session update for the data stream with the first priority level includes a current PDU session update for the data stream with the first priority level.

In an embodiment, the current session update for the data stream with the first priority level, in addition to including a current PDU session update for the data stream with the first priority level, also includes at least one of the following: Policy and Charging Control (PCC) rule update; QoS policy update; or AF session update.

As an example, the current session update for the data stream with the first priority level includes a current PDU session update, a PCC rule update, a QoS policy update, and an AF session release for the data stream with the first priority level.

In the above implementation(s), NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Network Exposure Function (NEF). FIG. 6 is a flow chart of a method performed by NEF according to an example embodiment.

As shown in FIG. 6, the method includes:
step 601, receiving a session request sent by an Application Function (AF), where the session request includes relationship information between data streams in an extended reality media service group, and the relationship information includes at least one of the following: dependency information or priority information;
step 602, determining whether to authorize the data streams in the session request based on the relationship information; and
step 603, in response to the priority information including multiple priority levels and an authorization failure occurring for a data stream with a priority level, triggering the execution of a PCC rule update and/or a QoS authorization update for the data streams in the extended reality media service group based on a operator policy; and in response to the dependency information including multiple dependency levels and an authorization failure occurring for one or more data streams in the data stream set with the first dependency level, triggering the execution of a PCC rule update and/or a QoS authorization update for the data streams in the extended reality media service group based on the operator policy,
where the data streams in the data stream set with the first dependency level are dependent on each other.

In an embodiment, NEF receives a session request sent by AF. The session request includes relationship information between data streams in an extended reality media service group. The relationship information may be dependency information about the dependency relationship between data streams and/or priority information about the priority relationship between data streams. NEF determines whether to authorize these data streams based on the relationship information included in the received session request. In a scenario where the priority information of the data streams includes multiple priority levels, if an authorization failure occurs for a data stream with a certain priority level, PCC rule update and/or QOS authorization update for the data stream in the extended reality media service group is triggered based on an operator policy. That is, in a scenario where the authorization failure occurs for a data stream with a certain priority level, PCC rule update and/or QoS authorization update for the corresponding data stream is triggered based on the operator policy.

In an embodiment, NEF receives a session request sent by AF. The session request includes relationship information between data streams in an extended reality media service group. The relationship information may be dependency information about the dependency relationship between data streams and/or priority information about the priority relationship between data streams. NEF determines whether to authorize these data streams based on the relationship information included in the received session request. In a scenario where the dependency information of the data streams includes multiple dependency levels, if an authorization failure occurs for a data stream with a first dependency level (i.e., a strong dependency level), a PCC rule update and/or QoS authorization update for the data streams in the extended reality media service group is triggered based on a operator policy. That is, in a scenario where the authorization failure occurs for a data stream with a strong dependency relationship, a PCC rule update and/or QoS authorization update for the corresponding data stream is triggered based on the operator policy. Here, the data streams in the data stream set with the first dependency level are dependent on each other, indicating that the data streams in the data stream set with the first dependency level have a strong dependency relationship with each other.

As an example, based on the operator policy, the PCC rule update and/or QoS degradation for the corresponding data stream is triggered. Further, based on the operator policy, the AF session release for the corresponding data stream is also triggered.

In the above implementation(s), NEF receives the dependency relationship and/or priority relationship between the data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

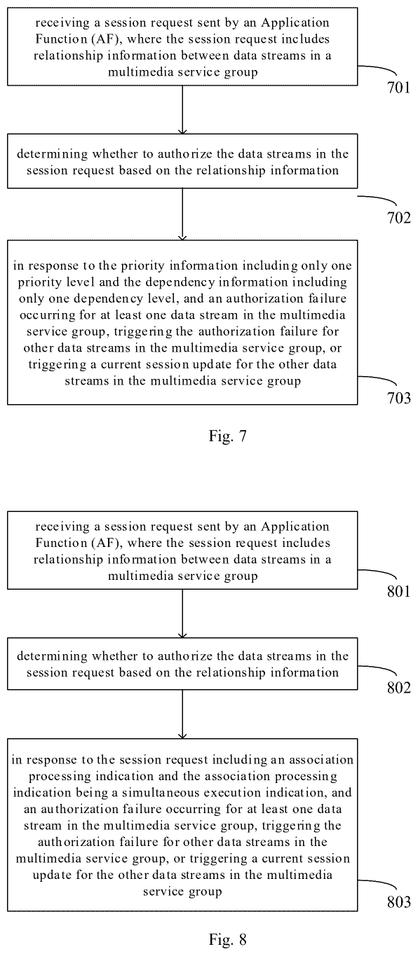

An embodiment of the present disclosure provides a method for authorizing an extended reality media service, which is performed by a Network Exposure Function (NEF). FIG. 7 is a flowchart of a method performed by NEF according to an example embodiment.

As shown in FIG. 7, the method includes:
step 701, receiving a session request sent by an Application Function (AF), where the session request includes relationship information between data streams in an extended reality media service group, and the relationship information includes at least one of the following: dependency information or priority information;
step 702, determining whether to authorize the data streams in the session request based on the relationship information; and
step 703, in response to the priority information including only one priority level and the dependency information including only one dependency level, and an authorization failure occurring for at least one data stream in the extended reality media service group, triggering the authorization failure for other data streams in the extended reality media service group, or triggering the current session update for the other data streams in the extended reality media service group.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize these data streams based on the relationship information included in the received session request. In a scenario where the priority information includes only one priority level and the dependency information includes only one dependency level for the data streams, that is, the priority levels of the data streams in the extended reality media service group are the same and the dependency relationships between them are the same, if an authorization failure occurs for a data stream, then the authorization failure for other data streams in the new session request is triggered, or the current session update for other data streams in the current session request is triggered. Other data streams refer to those data streams other than the data stream, for which the authorization failure occurs, in the data streams of the extended reality media service group. This indicates that in this scenario, the data streams in the extended reality media service group affect the authorization for each other.

In an embodiment, the current session update for other data streams includes the current PDU session update for other data streams.

In an embodiment, the current session update for other data streams includes the current PDU session update and QoS authorization withdrawal for other data streams. In an embodiment, the current session update for other data streams includes the current PDU session update and AF session release for other data streams. In an embodiment, the current session update for other data streams includes the current PDU session update, QoS authorization withdrawal and AF session release for other data streams.

In the above implementation(s), NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Network Exposure Function (NEF). FIG. 8 is a flow chart of a method performed by NEF according to an example embodiment.

As shown in FIG. 8, the method includes:
step 801, receiving a session request sent by an Application Function (AF), where the session request includes relationship information between data streams in an extended reality media service group, and the relationship information includes at least one of the following: dependency information or priority information;
step 802, determining whether to authorize the data streams in the session request based on the relationship information;
step 803, in response to the session request including an association processing indication and the association processing indication being a simultaneous execution indication, and an authorization failure occurs for at least one data stream in the extended reality media service group, triggering the authorization failure for other data streams in the extended reality media service group, or triggering the current session update for other data streams in the extended reality media service group,
where the association processing indication indicates that association processing is applied to the data streams in the extended reality media service group.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize these data streams based on the relationship information included in the received session request. In a scenario where the session request includes an association processing indication and the association processing indication is a simultaneous execution indication, that is, the indication is to use a synchronous processing mode for each data stream, if an authorization failure occurs for a data stream, the failure authorization for other data streams in the new session request is triggered, or the current session update for other data streams in the current session request is triggered. Other data streams refer to the data streams in the extended reality media service group except for the data stream for which the authorization failure occurs. In this scenario, NEF determines authorization or session update for other data streams based on the association processing indication carried in the session request.

The simultaneous execution indication here means that if an authorization failure occurs for a data stream in the extended reality media service group, the authorization withdrawl or AF session release is triggered for the authorized data streams in the extended reality media service group, that is, multiple data streams in the extended reality media service group are synchronously processed.

In an embodiment, the current session update for other data streams includes the current PDU session update for other data streams.

In an embodiment, the current session update for other data streams includes the current PDU session update and QoS authorization withdrawal for other data streams. In an embodiment, the current session update for other data streams includes the current PDU session update and the AF session release for other data streams. In an embodiment, the current session update for other data streams includes the current PDU session update, QoS authorization withdrawal and AF session release for other data streams.

In the above embodiment(s), NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

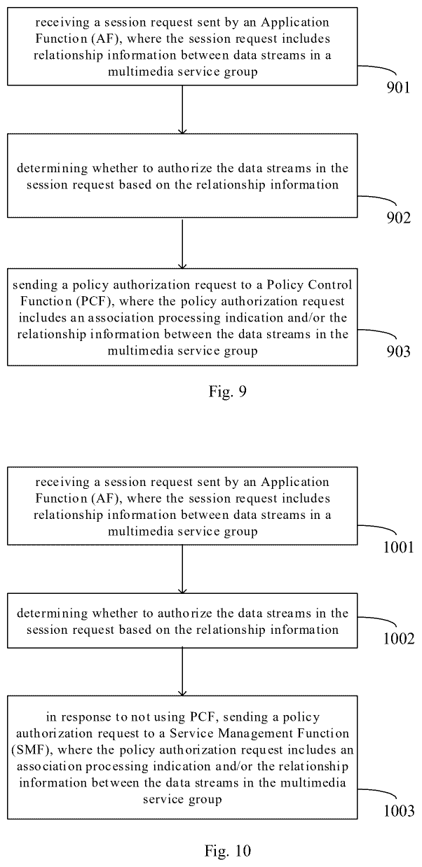

An embodiment of the present disclosure provides a method for authorizing an extended reality media service, which is performed by the Network Exposure Function (NEF). FIG. 9 is a flow chart of a method performed by NEF according to an example embodiment.

As shown in FIG. 9, the method includes:
step 901, receiving a session request sent by an Application Function (AF), where the session request includes relationship information between data streams in an extended reality media service group, and the relationship information includes at least one of the following: dependency information or priority information;
step 902, determining whether to authorize the data streams in the session request based on the relationship information;
step 903, sending a policy authorization request to a Policy Control Function (PCF), where the policy authorization request includes an association processing indication and/or the relationship information between the data streams in the extended reality media service group,
where the association processing indication indicates that association processing is applied to the data streams in the extended reality media service group.

In an embodiment, NEF receives a session request sent by AF. The session request includes relationship information between data streams in an extended reality media service group. The relationship information here may be dependency information about the dependency relationship between data streams and/or priority information about the priority relationship between data streams. NEF determines whether to authorize the data streams based on the relationship information included in the received session request. Then, a policy authorization request is sent to PCF, such as Npcf_PolicyAuthorization_Create request, which includes the association processing indication and/or the relationship information between data streams, so that PCF can execute a policy decision based on such information.

In an embodiment, if the extended reality media service corresponds to multiple user devices and is thus associated with multiple PCFs, NEF sends a policy authorization request to multiple PCFs associated with the extended reality media service respectively.

In an embodiment, if the extended reality media service corresponds to multiple user devices and is thus associated with multiple PCFs, NEF sends a policy authorization request to a default PCF among multiple PCFs associated with the extended reality media service. The default PCF then sends the information in the policy authorization request to other PCFs associated with the extended reality media service.

In the above embodiment(s), NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Network Exposure Function (NEF). FIG. 10 is a flow chart of a method performed by NEF according to an example embodiment.

As shown in FIG. 10, the method includes:
step 1001, receiving a session request sent by an Application Function AF, where the session request includes relationship information between data streams in an extended reality media service group, and the relationship information includes at least one of the following: dependency information or priority information;
step 1002, determining whether to authorize the data streams in the session request based on the relationship information;
step 1003, in response to not using PCF, sending a policy authorization request to a Service Management Function (SMF), where the policy authorization request includes an association processing indication and/or the relationship information between the data streams in the extended reality media service group,
where the association processing indication indicates that association processing is applied to the data streams in the extended reality media service group.

In an embodiment, NEF receives a session request sent by AF. The session request includes relationship information between data streams in the extended reality media service group. The relationship information here may be dependency information about the dependency relationship between data streams and/or priority information about the priority relationship between data streams. NEF determines whether to authorize these data streams based on the relationship information included in the received session request. In a scenario where PCF is not used, NEF sends a policy authorization request to SMF, and the policy authorization request includes the association processing indication and/or the relationship information between data streams, so that SMF can execute a policy decision based on such information.

In the above implementation(s), NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Policy Control Function (PCF). FIG. 11 is a flow chart of a method performed by a PCF according to an example embodiment.

As shown in FIG. 11, the method includes:
step 1101, receiving a policy authorization request sent by a Network Exposure Function (NEF), where the policy authorization request includes an association processing indication and/or relationship information between data streams in an extended reality media service group included in a session request,
where the relationship information includes at least one of the following: dependency information or priority information, and the association processing indication indicates that association processing is applied to the data streams in the extended reality media service group.

In an embodiment, PCF receives a policy authorization request sent by NEF. The policy authorization request includes the association processing indication and/or the relationship information between data streams in an extended reality media service group included in an AF session request. The relationship information here may be dependency information about the dependency relationship between data streams and/or priority information about the priority relationship between data streams.

As an example, PCF receives an Npcf_PolicyAuthorization_Create request sent by NEF.

In the above implementation(s), PCF receives the policy authorization request sent by NEF, and obtains the association processing indication and/or the relationship information between the data streams in the extended reality media service group carried therein, so that PCF can execute a policy decision based on the above relationship information and/or association processing indication. In this way, these relationships between data streams can be effectively identified and utilized, which is helpful for the transmission and control of the network and services, and is also more helpful for service assurance and user experience.

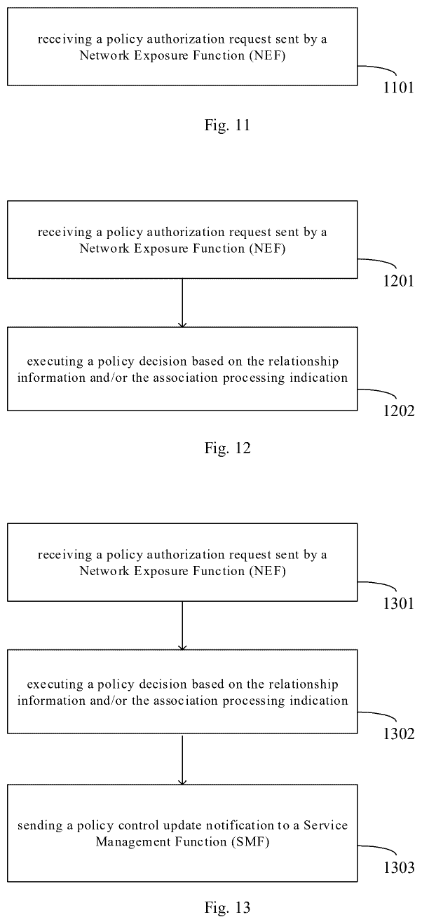

An embodiment of the present disclosure provides a method for authorizing an extended reality media service, which is performed by the Policy Control Function (PCF). FIG. 12 is a flow chart of a method performed by PCF according to an example embodiment.

As shown in FIG. 12, the method includes:
step 1201, receiving a policy authorization request sent by a Network Exposure Function (NEF), where the policy authorization request includes an association processing indication and/or relationship information between data streams in the extended reality media service group included in the session request; and
step 1202, executing a policy decision based on the relationship information and/or the association processing indication,
where the relationship information includes at least one of the following: dependency information or priority information, and the association processing indication indicates that association processing is applied to the data streams in the extended reality media service group.

In an embodiment, PCF receives a policy authorization request sent by NEF. The policy authorization request includes the association processing indication and/or the relationship information between data streams in the extended reality media service group included in the AF session request. The relationship information here may be dependency information about the dependency relationship between data streams and/or priority information about the priority relationship between data streams. Then, PCF executes a policy decision based on the above relationship information and/or association processing indication.

In an embodiment, PCF executing the policy decision includes:
generating or updating a Policy and Charging Control (PCC) rule.

In an embodiment, PCF executing the policy decision includes executing one of the following based on the above relationship information:
executing Quality of Service (QoS) authorization or update for a specific data stream;
executing QoS authorization or update for all data streams in a QoS data stream; or
executing QoS authorization or update for all data streams in a Packet Data Unit (PDU) session.

In the above embodiment(s), PCF receives the policy authorization request sent by NEF, and obtains the association processing indication and/or the relationship information between data streams in the extended reality media service group carried therein, so that PCF can execute a policy decision based on the above relationship information and/or association processing indication. In this way, these relationships between data streams can be effectively identified and utilized, which is helpful for the transmission and control of the network and services, and is also more helpful for service assurance and user experience.

An embodiment of the present disclosure provides a method for authorizing an extended reality media service, which is performed by a Policy Control Function (PCF). FIG. 13 is a flow chart of a method performed by a PCF according to an example embodiment.

As shown in FIG. 13, the method includes:
step 1301, receiving a policy authorization request sent by a Network Exposure Function (NEF), where the policy authorization request includes an association processing indication and/or relationship information between data streams in an extended reality media service group included in a session request;
step 1302, executing a policy decision based on the relationship information and/or the association processing indication;
step 1303, sending a policy control update notification to a Service Management Function (SMF),
where the relationship information includes at least one of the following: dependency information or priority information, and the association processing indication indicates that association processing is applied to the data streams in the extended reality media service group.

In an embodiment, PCF receives a policy authorization request sent by NEF. The policy authorization request includes an association processing indication and/or relationship information between data streams in an extended reality media service group included in an AF session request. The relationship information here may be dependency information about the dependency relationship between data streams and/or priority information about the priority relationship between data streams. Then, PCF executes a policy decision based on the above relationship information and/or association processing indication, and sends a policy control update notification to SMF.

As an example, PCF sends Npcf_SMPolicyControl_UpdateNotify to SMF to update the PDU session of SMF, including updating PCC rule and QoS policy.

In the above implementation(s), PCF receives a policy authorization request sent by NEF, and obtains the association processing indication and/or the relationship information between data streams in the extended reality media service group carried therein, so that PCF can execute a policy decision based on the above relationship information and/or association processing indication. In this way, these relationships between data streams can be effectively identified and utilized, which is helpful for the transmission and control of the network and services, and is also more helpful for service assurance and user experience.

An embodiment of the present disclosure provides a method for authorizing an extended reality media service.

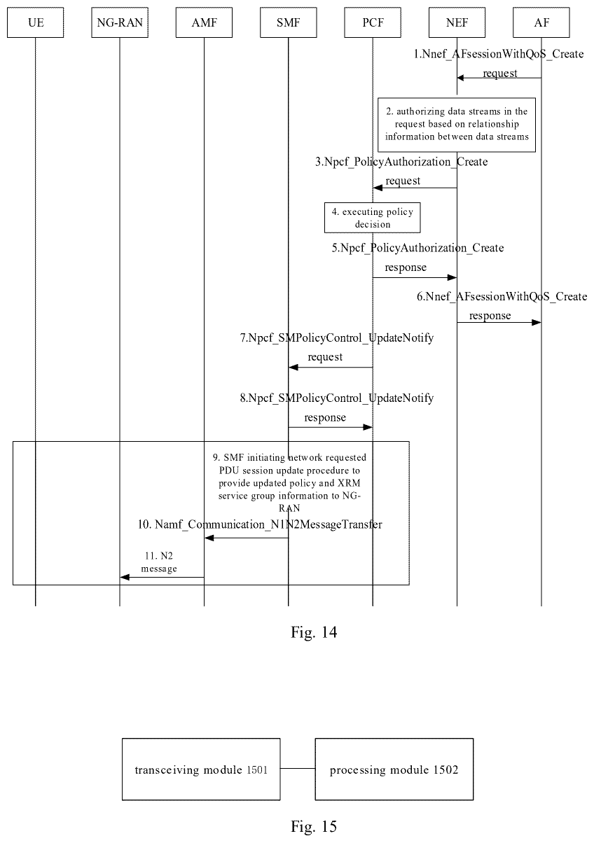

As shown in FIG. 14, the method includes the following.
1. AF sends a session request to NEF, where the session request carries the XRM service group information and the relationship information between data streams in the service group. For example, AF creates the session request by sending the Nnef_AFsessionWithQoS_Create request.
2. NEF authorizes the data streams in the received session request based on the relationship information between the data streams.
3. NEF determines whether to send the session request to PCF through TSCTSF or directly. If it is determined to send the session request to PCF, it sends a policy authorization request to PCF, such as sending the Npcf_PolicyAuthorization_Create request, which includes an association processing indication and/or relationship information between data streams in the extended reality media service group, and the XRM service group information. If the extended reality media service corresponds to multiple user devices and is thus associated with multiple PCFs, NEF sends a policy authorization request to multiple PCFs associated with the extended reality media service respectively.
4. PCF executes a policy decision based on the received relationship information and/or association processing indication, such as generating or updating a PCC rule. If the extended reality media service corresponds to multiple user devices and is thus associated with multiple PCFs, one of the PCFs, after executing the policy decision, sends Npcf_PolicyAuthorization_Notify to other PCFs associated with the extended reality media service group, so that other PCFs are triggered to perform a data stream rule update.
5. PCF sends Npcf_PolicyAuthorization_Create response message to NEF.
6. NEF sends Nnef_AFsessionWithQoS_Create response message to AF to notify AF whether its session request is authorized.
7. PCF sends to SMF a policy control update notification, such as Npcf_SMPolicyControl_UpdateNotify, which includes policy information that may be updated for the PDU session and also includes the XRM service group information in the AF session request.
8. SMF sends to PCF a response message, such as Npcf_SMPolicyControl_UpdateNotify response.
9. SMF determines the authorized QoS for the QoS flow based on the PCC rule in the policy control update notification received from PCF, and initiates the network requested PDU session update procedure to provide the updated policy and XRM service group information to NG-RAN.
10. SMF sends to AMF Namf_Communication_N1N2MessageTransfer message, which includes the XRM service group information.
11. AMF sends to NG-RAN an N2 message, which includes the XRM service group information.

An embodiment of the present disclosure provides an apparatus for authorizing an extended reality media service.

As shown in FIG. 15, the apparatus includes:
a transceiving module 1501 configured to receive a session request sent by an Application Function (AF), where the session request includes relationship information between data streams in an extended reality media service group, and the relationship information includes at least one of the following: dependency information or priority information; and
a processing module 1502 configured to determine whether to authorize the data streams in the session request based on the relationship information.

In some implementations, the processing module 1502 is further configured to:
in response to the priority information including multiple priority levels and an authorization failure occurring for a data stream with a first priority level, trigger the authorization failure for a data stream with a second priority level, or trigger the current session update for the data stream with the second priority level,
where the first priority level is higher than the second priority level.

In some implementations, the processing module 1502 is further configured to:
in response to the dependency information including multiple dependency levels and an authorization failure occurring for one or more data streams in the data stream set with the first dependency level, trigger the authorization failure for other data streams in the data stream set with the first dependency level, or trigger the current session update for other data streams in the data stream set with the first dependency level,
where the data streams in the data stream set with the first dependency level are dependent on each other.

In some implementations, the current session update includes:
current Packet Data Unit (PDU) session update.

In some implementations, the current session update also includes:
Quality of Service (QoS) authorization withdrawal and/or AF session release.

In some implementations, the processing module 1502 is further configured to:
in response to the priority information including multiple priority levels and an authorization failure occurring for a data stream with a second priority level, trigger the current session update for a data stream with a first priority level, where the first priority level is higher than the second priority level.

In some implementations, triggering the current session update for the data stream with the first priority level includes:
PDU session update.

In some implementations, triggering the current session update for the data stream with the first priority level also includes at least one of the following:
Policy and Charging Control (PCC) rule update;
QoS policy update; or
AF session update.

In some implementations, the processing module 1402 is further configured to:
in response to the priority information including multiple priority levels and an authorization failure occurring for a data stream with a priority level, trigger the execution of PCC rule update and/or QoS authorization update for the data streams in the extended reality media service group based on an operator policy; and
in response to the dependency information including multiple dependency levels and an authorization failure occurring for one or more data streams in the data stream set with the first dependency level, trigger the execution of PCC rule update and/or QoS authorization update for the data streams in the extended reality media service group based on the operator policy,
where the data streams in the data stream set with the first dependency level are dependent on each other.

In some implementations, the processing module 1502 is further configured to:
in response to the priority information including only one priority level and the dependency information including only one dependency level, and an authorization failure occurring for at least one data stream in the extended reality media service group, trigger the authorization failure for other data streams in the extended reality media service group, or trigger the current session update for other data streams in the extended reality media service group.

In some implementations, the processing module 1502 is further configured to:
in response to the session request including an association processing indication and the association processing indication being a simultaneous execution indication, and an authorization failure occurring for at least one data stream in the extended reality media service group, trigger the authorization failure for other data streams in the extended reality media service group, or trigger the current session update for other data streams in the extended reality media service group,
where the association processing indication indicates that association processing is applied to the data streams in the extended reality media service group.

In some implementations, the current session update includes:
current PDU session update.

In some implementations, the current session update also includes:
QoS authorization withdrawal and/or AF session release.

In some implementations, the transceiving module 1501 is further configured to:
send a policy authorization request to a Policy Control Function (PCF), where the policy authorization request includes an association processing indication and/or relationship information between the data streams in the extended reality media service group,
where the association processing indication indicates that association processing is applied to the data streams in the extended reality media service group.

In some implementations, the transceiving module 1501 is further configured to:
in response to the extended reality media service corresponding to multiple user devices, send the policy authorization request to multiple PCFs associated with the extended reality media service respectively.

In some implementations, the transceiving module 1501 is further configured to:
in response to the extended reality media service corresponding to multiple user devices, send the policy authorization request to a default PCF among multiple PCFs associated with the extended reality media service.

In some implementations, the transceiving module 1501 is further configured to:
in response to not using PCF, send a policy authorization request to the Service Management Function (SMF), where the policy authorization request includes an association processing indication and/or relationship information between the data streams in the extended reality media service group,
where the association processing indication indicates that association processing is applied to the data streams in the extended reality media service group.

An embodiment of the present disclosure provides an apparatus for authorizing an extended reality media service.

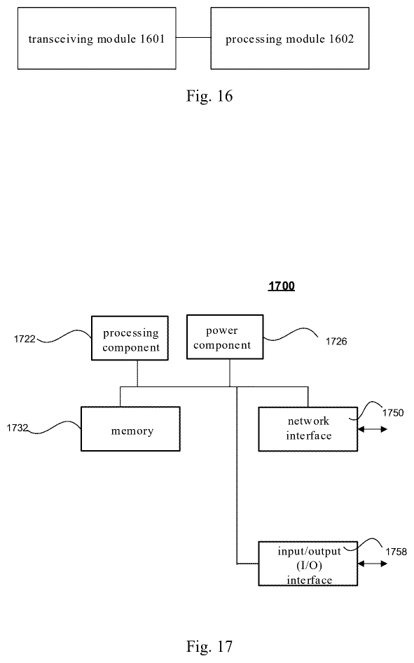

As shown in FIG. 16, the apparatus includes:
a transceiving module 1601 configured to receive a policy authorization request sent by a Network Exposure Function (NEF), where the policy authorization request includes an association processing indication and/or relationship information between the data streams in the extended reality media service group included in the session request,
where the relationship information includes at least one of the following: dependency information or priority information, and the association processing indication indicates that association processing is applied to the data streams in the extended reality media service group.

In some implementations, the apparatus further includes:
a processing module 1602 configured to execute a policy decision based on the relationship information and/or the association processing indication.

In some implementations, executing the policy decision includes:
generating or updating a Policy and Charging Control (PCC) rule.

In some implementations, executing the policy decision includes executing one of the following based on the relationship information:
executing Quality of Service (QoS) authorization or update for a specific data stream;
executing QoS authorization or update for all data streams in a QoS data stream; or
executing QoS authorization or update for all data streams in a Packet Data Unit (PDU) session.

In some implementations, the transceiving module 1501 is further configured to:
send a policy control update notification to the Service Management Function (SMF).

An embodiment of the present disclosure provides a communication device, including a processor and a memory.

The memory is configured to store a computer program.

The processor is configured to execute the computer program to implement the above-mentioned method for authorizing an extended reality media service.

An embodiment of the present disclosure provides a communication device, including a processor and a memory.

The memory is configured to store a computer program.

The processor is configured to execute the computer program to implement the above-mentioned method for authorizing an extended reality media service.

An embodiment of the present disclosure provides a computer-readable storage medium, in which instructions are stored. When the instructions are called and executed on a computer, the computer is caused to perform the above-mentioned method for authorizing an extended reality media service. The computer-readable storage medium may be a non-transistory computer-readable storage medium including instructions. For example, the non-transistory computer-readable storage medium may be a ROM, a random access memory (RAM), a CD-ROM, a tape, a floppy disk, an optical data storage device, etc.

FIG. 17 is a block diagram of an apparatus 1700 for authorizing an extended reality media service according to an example embodiment. For example, the apparatus 1700 may be provided as a network element at a core network side, such as a Network Exposure Function (NEF), a Policy Control Function (PCF), an Application Function (AF), etc. Referring to FIG. 17, the apparatus 1700 includes a processing component 1722, which further includes one or more processors, and a memory resource represented by a memory 1732 for storing instructions executable by the processing component 1722, such as an application program. The application program stored in the memory 1732 may include one or more modules, each corresponding to a set of instructions. In addition, the processing component 1722 is configured to execute instructions to perform the above-mentioned method for authorizing an extended reality media service.

The apparatus 1700 may also include a power component 1726 configured to perform power management for the apparatus 1700, a wired or wireless network interface 1750 configured to connect the apparatus 1700 to the network, and an input/output (I/O) interface 1759. The apparatus 1700 may operate based on an operation system stored in the memory 1732, such as Windows Server™, Mac OS X™, Unix™, Linux™, FreeBSD™, or the like.

After considering the specification and practicing the contents disclosed herein, it will be easy for those skilled in the art to think of other implementations of the embodiments of the present disclosure. The present application is intended to cover any variation, use, or adaptive change of the embodiments of the present disclosure, which follows the general principles of the embodiments of the present disclosure and includes common knowledge or conventional technical means in the technical field that are not disclosed in the present disclosure. The specification and embodiments are only to be regarded as examples, and the true scope and spirit of the embodiments of the present disclosure are indicated by the following claims.

It should be understood that the embodiments of the present disclosure are not limited to the precise structures described above and shown in the accompanying drawings, and various modifications and changes may be made without departing from the scope thereof. The scope of the embodiments of the present disclosure is limited only by the appended claims.

### INDUSTRIAL APPLICABILITY

NEF receives the dependency relationship and/or priority relationship between data streams in the media service group in the session request, and determines whether to authorize the data streams based on these relationships. In this way, these relationships between data streams can be effectively identified and utilized, which is helpful for the transmission and control of the network and services, and is also more helpful for service assurance and user experience.

1. A method for authorizing an extended reality media service, performed by a Network Exposure Function (NEF), comprising:
receiving a session request sent by an Application Function (AF), wherein the session request comprises relationship information between data streams in an extended reality media service group, and the relationship information comprises at least one of dependency information or priority information; and
determining whether to authorize the data streams in the session request based on the relationship information.

2. The method according to claim 1, further comprising:
in response to the priority information comprising multiple priority levels and an authorization failure occurring for a data stream with a first priority level, triggering the authorization failure for a data stream with a second priority level, or triggering a current session update for the data stream with the second priority level,
wherein the first priority level is higher than the second priority level.

3. The method according to claim 1, further comprising:
in response to the dependency information comprising multiple dependency levels and an authorization failure occurring for one or more data streams in a data stream set with a first dependency level, triggering the authorization failure for other data streams in the data stream set with the first dependency level, or triggering a current session update for the other data streams in the data stream set with the first dependency level,
wherein the data streams in the data stream set with the first dependency level are dependent on each other.

4. The method according to claim 2, wherein the current session update comprises at least one of:
current Packet Data Unit (PDU) session update;
Quality of Service (QoS) authorization withdrawal; or
AF session release.

5. (canceled)

6. The method according to claim 1, further comprising:
in response to the priority information comprising multiple priority levels and an authorization failure occurring for a data stream with a second priority level, triggering a current session update for a data stream with a first priority level,
wherein the first priority level is higher than the second priority level.

7. The method according to claim 6, wherein triggering the current session update for the data stream with the first priority level comprises at least one of:
PDU session update;
Policy and Charging Control (PCC) rule update;
QoS policy update; or
AF session update.

8. (canceled)

9. The method according to claim 1, further comprising:
in response to the priority information comprising multiple priority levels and an authorization failure occurring for a data stream with a priority level, triggering execution of PCC rule update and/or QOS authorization update for the data streams in the extended reality media service group based on an operator policy; and
in response to the dependency information comprising multiple dependency levels and an authorization failure occurring for one or more data streams in a data stream set with a first dependency level, triggering the execution of the PCC rule update and/or the QoS authorization update for the data streams in the extended reality media service group based on the operator policy,
wherein the data streams in the data stream set with the first dependency level are dependent on each other.

10. The method according to claim 1, further comprising:
in response to the priority information comprising only one priority level and the dependency information comprising only one dependency level, and an authorization failure occurring for at least one data stream in the extended reality media service group, triggering the authorization failure for other data streams in the extended reality media service group, or triggering a current session update for the other data streams in the extended reality media service group.

11. The method according to claim 1, further comprising:
in response to the session request comprising an association processing indication and the association processing indication being a simultaneous execution indication, and an authorization failure occurring for at least one data stream in the extended reality media service group, triggering the authorization failure for other data streams in the extended reality media service group, or triggering a current session update for the other data streams in the extended reality media service group,
wherein the association processing indication indicates that association processing is applied to the data streams in the extended reality media service group.

12. The method according to claim 10, wherein the current session update comprises at least one of:
current PDU session update;
QoS authorization withdrawal; or
AF session release.

13. (canceled)

14. The method according to claim 1, further comprising:
sending a policy authorization request to a Policy Control Function (PCF), wherein the policy authorization request comprises an association processing indication and/or the relationship information between the data streams in the extended reality media service group,
wherein the association processing indication indicates that association processing is applied to the data streams in the extended reality media service group.

15. The method according to claim 14, wherein sending the policy authorization request to the PCF comprises:
in response to the extended reality media service corresponding to multiple user devices, sending the policy authorization request to multiple PCFs associated with the extended reality media service respectively; or
in response to the extended reality media service corresponding to multiple user devices, sending the policy authorization request to a default PCF among multiple PCFs associated with the extended reality media service.

16. (canceled)

17. The method according to claim 1, further comprising:
in response to not using a PCF, sending a policy authorization request to a Service Management Function SMF, wherein the policy authorization request comprises an association processing indication and/or the relationship information between the data streams in the extended reality media service group,
wherein the association processing indication indicates that association processing is applied to the data streams in the extended reality media service group.

18. A method for authorizing an extended reality media service, performed by a Policy Control Function (PCF), comprising:
receiving a policy authorization request sent by a Network Exposure Function (NEF), wherein the policy authorization request comprises an association processing indication and/or relationship information between data streams in an extended reality media service group comprised in a session request,
wherein the relationship information comprises at least one of dependency information or priority information, and the association processing indication indicates that association processing is applied to the data streams in the extended reality media service group.

19. The method according to claim 18, further comprising:
executing a policy decision based on the relationship information and/or the association processing indication.

20. The method according to claim 19, wherein executing the policy decision comprises:
generating or updating a Policy and Charging Control (PCC) rule.

21. The method according to claim 19, wherein executing the policy decision comprises executing one of the following based on the relationship information:
executing a Quality of Service (QoS) authorization or update for a specific data stream;
executing the QoS authorization or update for all the data streams in a QoS data stream; or
executing the QoS authorization or update for all the data streams in a Packet Data Unit (PDU) session.

22. The method according to claim 19, further comprising:
sending a policy control update notification to a Service Management Function (SMF).

23. (canceled)

24. (canceled)

25. A communication device, comprising a processor and a memory, wherein
the memory is configured to store a computer program; and
the processor is configured to execute the computer program to implement a method for authorizing an extended reality media service, comprising:
receiving a session request sent by an Application Function (AF), wherein the session request comprises relationship information between data streams in an extended reality media service group, and the relationship information comprises at least one of dependency information or priority information; and
determining whether to authorize the data streams in the session request based on the relationship information.

26. A communication device, comprising a processor and a memory, wherein
the memory is configured to store a computer program; and
the processor is configured to execute the computer program to implement the method for authorizing an extended reality media service according to claim 18.

27. (canceled)
